(19) United States
(12) Patent Application Publication
(10) Pub. No.: US 2026/0025638 A1
(43) Pub. Date: Jan. 22, 2026

(54) LOCATION BASED SETTING UPDATES

(71) Applicant: T-MOBILE INNOVATIONS LLC, Overland Park, KS (US)

(72) Inventor: Pablo C. LOPEZ-TERUEL, Sammamish, WA (US)

(21) Appl. No.: 18/777,313

(22) Filed: Jul. 18, 2024

(51) Int. Cl. H04W 4/029; G06F 3/0484

(52) U.S. Cl. CPC H04W 4/029; G06F 3/0484

(57) ABSTRACT

Embodiments of the present disclosure are directed to systems and methods for determining sets of user computing device settings that are associated with different locations based on historical use data. A user computing device associated with these sets of user computing device settings may determine that the user computing device has moved from a first location to a second location. Based on determining that the user computing device is located at the second location, the user computing device may update from a first set of user computing device settings to a second set of user computing device settings. Additionally or alternatively, determining that the user computing device has moved from a first location to a second location may cause display of a notification recommending that the user computing device settings be updated to the second set of settings.

### SUMMARY

The present disclosure is directed to systems and methods for causing updates to the settings of a user device based on historical use data and changes in location.

According to various aspects of the technology, historical use data may be utilized to determine sets of user computing device settings that are associated with various locations. It may be determined that the user computing device has traveled from a first location associated with a first set of user computing device settings to a second location associated with a second set of user computing device settings. Based on determining that the user computing device has traveled to the second location, the user computing device may automatically update to the second set of use computing device settings. In additional or alternative embodiments, a selectable notification recommending that the user computing device settings be updated to the second set of user computing device settings based on determining that the user computing device is located at the second location. Based on receiving a selection of the selectable notification, the user computing device settings may be updated to the second set of user computing device settings.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example of a computer environment, in accordance with one or more embodiments;

FIG. 2 depicts a diagram of a network environment, in accordance with one or more embodiments;

FIG. 3 is a flow chart of a method for network communication, in accordance with one or more embodiments;

FIG. 4 is a flow chart of an additional or alternative method for network communication in accordance with one or more embodiments;

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “network access technology (NAT)” is synonymous with wireless communication protocol and is an umbrella term used to refer to the particular technological standard/protocol that governs the communication between a UE (User Equipment) and a base station; examples of network access technologies include 3G, 4G, 5G, 6G, 802.11x, and the like. The term “node” is used to refer to an access point that transmits signals to a UE and receives signals from the UE in order to allow the UE to connect to a broader data or cellular network (including by way of one or more intermediary networks, gateways, or the like)

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a user may actively customize any number of settings associated with a user device. Some of these settings may be, for example, ring tones, adjustments to volume, the enabling or disabling of a silent or loud mode, the adjustment of alarms, and the like. Additional or alternative examples of customizable settings may be any number of calendar notifications, automatic replies for email, text, or other forms of communication, or a do not disturb mode which silences all alerts associated with the user device.

Conventionally, in order to set or update these customizable settings, a user must manually navigate to and adjust the settings. This may be done through the use of a graphical user interface, voice commands, gesture commands, or any other form of manual interaction. For example, if a user would like to enable or disable an alarm, the user must manually interact with the user device and or an application or set of applications to navigate to and adjust the alarm. Further, if a user wanted to silence their user device, they would need to manually adjust the setting related to the volume of the user device or actively enable a do not disturb mode. It is not as simple as navigating to and adjusting settings though. These adjustments are not always desirable. In other words, some settings adjustments may be desired based on a location such that a first setting is optimal at one location but a second (different) setting is optimal at a second location. By way of an illustrative example, if a user were to go on a vacation and an alarm was no longer needed, the user would need to manually update the alarm by interacting with the user device. Further, if a user is traveling and needs to update a set of notifications associated with text or email, the user would need to manually navigate to and adjust said settings through interacting with the user device.

Unlike conventional solutions, the present disclosure provides a solution by which a user device may automatically update settings without manual interaction by a user. In embodiments, the automatic updates may be initiated based on changes in location. The present disclosure provides an environment in which a user device may collect and use historical use data, for example GPS data, patterns of setting changes, and/or user interactions with the user device, to determine various settings and/or sets of settings associated with various locations. Said locations may be categorized as home, work, away, or any other suitable location identifier. These locations and their associated settings may be determined by the user device without interaction by a user. Namely, a user is not required to set these locations or the settings associated with the locations. In additional or alternative embodiments, the historical use data may be used to update various settings of a user device based on changes in location that are associated with settings adjustments. Based on these determined associations, the user device may additionally or alternatively provide notifications recommending changes to settings which the user may confirm or deny. In additional or alternative embodiments, the user device may automatically (without user input) update settings based on changes in location.

These determined associations between sets of settings and user device locations may be used to provide automatic updates to settings of the user device. In additional or alternative embodiments, the determined locations may be used to provide notifications or recommendations to a user. For example, it may be determined that a user was previously located at a home location and is currently located at a work location. Based on this determination, the user device may automatically update any number of settings. These changes or recommendations may be made without the need for input by a user. For example, a user device may be located at a first location between the hours of 7 PM to 8 AM Monday through Friday. A user device may track this location internally and determine that this location is associated with a home location. In additional or alternative embodiments, the user device may be located at a second location between the hours of 9 AM to 5 PM Monday through Friday. The user device may track this change in location and determine that this second location is associated with a work location. Based on determining the home location, work location, change to the work location, change to the home location, change from the work location or change from the home location, the user device may provide recommendations to the user based on historical actions of the user.

In embodiments, the user device locations may be associated with a certain geographical area which may be defined by a radius, polygon, or any other geographical shape. This shape may define an area of influence of a particular type of location such as a work or a home location. Information about this location may be used to influence the size of this particular location such as increasing the size when it is determined that the settings associated with a work location should be activated before reaching an exact point. For example, it may be determined that the user device should enter a do not disturb mode at the parking lot several hundred feet away from the actual center of the work location. Or, in embodiments, it may be determined that notifications should be turned on or a do not disturb setting should be turned off when approaching a certain proximity from the home location, allowing the user to receive notifications as they approach their home. This could also be used to determine a radius from which user settings should not be updated. In an alternative example, the user device may determine that the do not disturb setting should not be enabled until the user device is directly on top of the work location. This would avoid potential scenarios in which a user is traveling past the work location and the user device automatically enables and then disables do not disturb as the user device travels past.

In additional or alternative embodiments, the user device may determine a standard schedule for a user of the user device based on the locations to which the user normally travels. If the location of a user device deviates from the standard locations, the user device may determine that the user device is located at or traveling to a third location. In some embodiments, the third location may be associated with a vacation location, or some other location associated with a change in the standard schedule. In said embodiment, the user device may recommend making changes to the settings to reflect the fact that the user device is located at a vacation location. The recommendations that the user device makes may vary from location to location. Further the recommendations may vary based on the time of day that the user visits locations.

Accordingly, a first aspect of the present disclosure is directed to a method for updating at least one setting of a user device, the method comprising determining, based on historical use data, a first set of settings associated with a first location and a second set of settings associated with a second location. The method further comprises determining that the user device has moved from the first location to the second location. The method further comprising automatically updating the user device from the first set of settings to the second set of settings.

A second aspect of the present disclosure is directed to a system for updating at least one setting of a user device, the system comprising one or more computer processing components configured to perform operations comprising determining, based on historical use data, a first set of settings associated with a first location and a second set of settings associated with a second location. The one or more computer processing components are further configured to determine that the user device has moved from the first location to the second location, and automatically update the user device from the first set of settings to the second set of settings.

Another aspect of the present disclosure is directed to a method for updating at least one setting of a user device, the method comprising determining, based on historical use data, a first set of settings associated with a first location and a second set of settings associated with a second location. The method further comprises determining that the user device has moved from the first location to the second location. The method further comprises causing display of a selectable notification recommending that the at least one setting be updated to the second set of settings, and based on receiving a selection of the selectable notification, updating the user device from the first set of settings to the second set of settings.

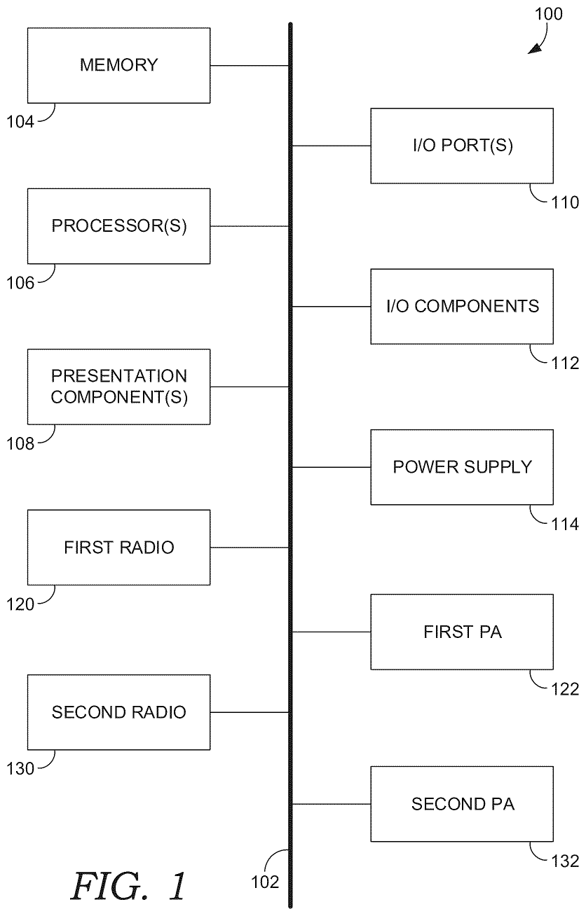

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to a an access point and receive one or more signals from the access point (or some other access point); the computing device 100 may be referred to herein as a user equipment, wireless communication device, or user device, The computing device 100 may take many forms; non-limiting examples of the computing device 100 include a cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate with a wireless network on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VOLTE, or other VOIP communications. In aspects, the first radio 120 and the second radio 130 may be configured to communicate using the same protocol but in other aspects they may be configure dot communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies.

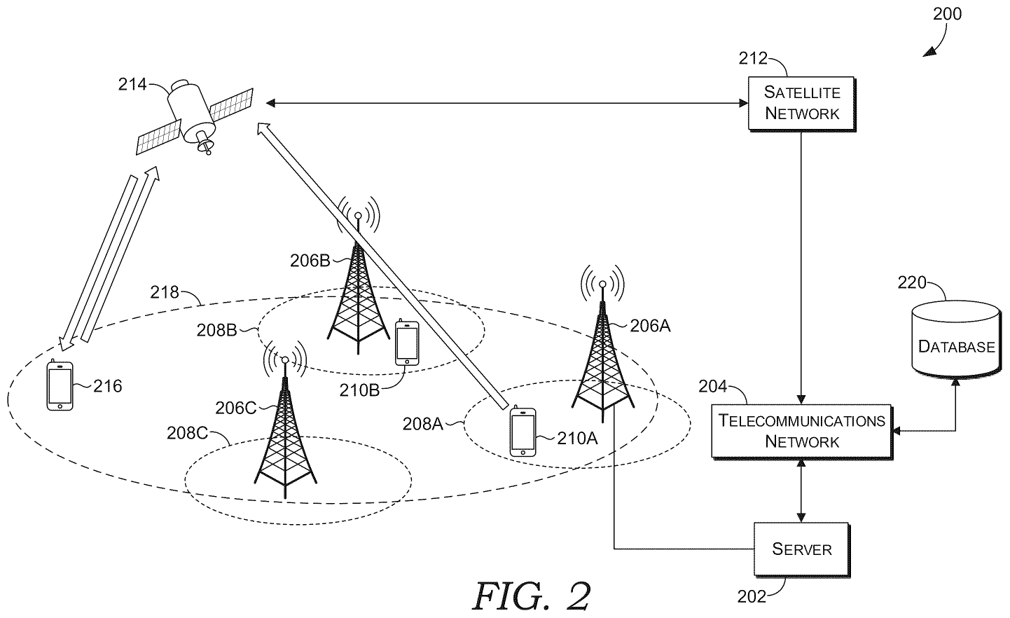

FIG. 2 depicts an example of a network environment 200, in accordance with one or more embodiments. The network environment 200 includes a server 202 having one or more processors. The server 202 operates within and thus is communicatively coupled to a telecommunications network 204 or its components. The server 202 is communicatively coupled to one or more base stations 206A, 206B, and 206C within the telecommunications network 204. Each of the one or more base stations 206A, 206B, and 206C has a corresponding coverage areas 208A, 208B, and 208C. The one or more base stations 206A, 206B, and 106C can provide telecommunications services to a user device over any number of locations such as user device location 210A and user device location 210B. One or more user devices associated with user device location 210A and user device location 210B may be such a device represented by computing device 100.

In the network environment 200 shown, the telecommunications network 204 interfaces with satellite network 212, which is also referred to as an aerospace network. In one aspect, the server 202 operates as, or is communicatively coupled to, a telecommunications core network component that acts as an interface between the satellite network 212 and the telecommunications network 204. The satellite network 212 can include one or more devices configured to act as aerospace access points, such as satellite 214. Although not shown, the satellite network 212 may interface with and communicate with one or more terrestrial radio elements that are not associated with the telecommunications network 204. The satellite 214 can provide connectivity to a user device such as a user device located at user device location 216 that is located within the coverage area 218 of the satellite 214.

In aspects, the user device associated with user device location 210A that is located within coverage area 208A communicates with the base station 206A, such that the base station 206A provides the user device associated with user device location 210A with connectivity to and services of the telecommunications network 204. In one such aspect, the user device associated with user device location 210A sends communications to the base station 206A over an uplink channel. Meanwhile, the user device associated with user device location 216 that is located within the coverage area 218 may send communications to the satellite 214 over an uplink channel. These communications of the user device associated with user device location 216 may be transmitted using the same particular radio frequencies designated for the uplink channel, and which are being used by the user device associated with user device location 210A to communicate with the base station 206A. Due to the proximity and/or at least a partial overlap of the coverage area 218 of the satellite 214 with the coverage area 208A of the base station 206A, the use of the same radio frequencies by the user device associated with user device location 210B and the user device associated with user device location 210A can allow for communication between coverage areas.

In additional or alternative embodiments, the same user device may be located at each of user device location 210A, user device location 210B, and user device location 216. The user device may determine that it has moved locations utilizing GPS or any other form of location determination system. For example, a user device may determine that it has moved from user device location 210A to user device location 210B by determining that the user device has disconnected from base station 206A and is now connected to base station 206B. Similarly, a user device may determine changes in location utilizing GPS data such as GPS data from a satellite such as satellite 214. This may be used to determine that a user device has moved from user device location 210A to user device location 216. In said embodiment, it is not the change in base station necessarily that is used to determine that the user device has moved, but GPS data.

Each of these separate locations represented by user device location 210A, user device location 210B, and user device location 216 are examples of ways in which a user device may move locations and how it is determined that the user device has moved from one location to another. A user device may detect any number of locations as a user moves about an environment in any number of manners. As discussed above and in more detail below, these distinct locations may be used along with other historical use data to determine locations which are associated with any number of user device settings. For example, a first set of settings may be associated with user device location 210A, a second set of settings may be associated with user device location 210B, and a third set of settings may be associated with user device location 216. Based on determining that the user device has moved between these three locations, the user device may automatically update the set of settings to the set of settings associated with the corresponding location.

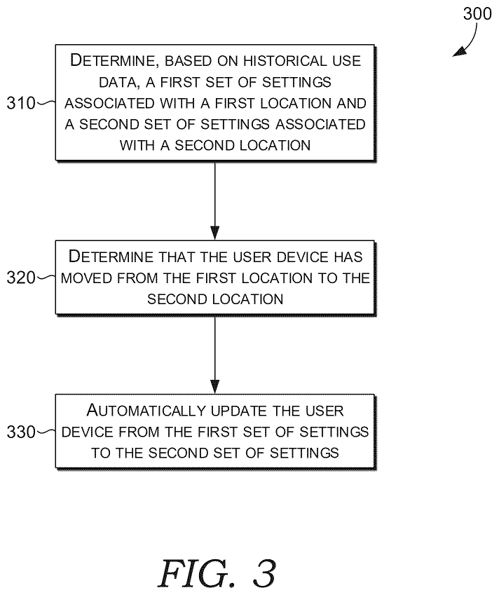

Turning now to FIG. 3 a flow chart is provided for a method 300 for updating at least one setting of a user device. By way of a high level example, a user device may regularly move between several distinct geographical locations throughout a set period of time. This may be for example throughout the same day, over multiple days, or over the course of multiple weeks. A user may regularly change the settings of their user device based on which location they are moving to over these changes in time. For example, a user may arrive at the same location every Monday through Friday which is associated with an office where they work. The user may manually change the user device to a silent or do not disturb mode when they arrive at this location. The user device may store this historical use data including location and settings over a period of time, and based on determining an association between this location and setting, the user device may automatically update the user device to a silent mode when it detects that the user has arrived at work. In additional or alternative embodiments, the user device may cause display of a selectable notification that recommends the any number of user settings be updated based on the determined change in location. Based on receiving a selection of the selectable notification, the setting may be automatically updated. For example, when a user device arrives at work, the user device may cause display of a notification recommending that the user device be set to silent. Based on receiving a selection of this notification, the user device may automatically be set to silent.

Moving to the steps of FIG. 3, at a first step 310, a first set of settings associated with a first location and a second set of settings associated with a second location are determined based on historical use data. In embodiments, these associations may be determined through the use of machine learning algorithms or other algorithms stored on the user computing device or in association with a server of a telecommunication network such as server 202. For example, the GPS location data of a user device as the user device moves throughout a day may be stored and fed to a machine learning program or other pattern recognition program. Further, use data such as settings turned on or off at various locations, or patterns of usage such as the types or number of applications used at various locations may also be stored and utilized to determine patterns of usage of the user device across various locations. This historical use data may be collected over any period of time. For example, historical use data of a 24 hour period may be utilized to determine the locations and associated settings for that 24 hour period. This historical use data may be utilized to determine locations such as a work location, home, location, travel location, etc. A user may regularly enable a silent mode for their user device when they arrive at the work location, and disable the silent mode when leaving the work location and moving to the travel location. The user device may recognize this pattern and associate the work location with an enabled silent mode and the travel location with a disabled silent mode.

In additional or alternative embodiments, the user may adjust the form and audibility of various push notifications in association with various locations. The user device or associated machine learning program may determine that a set of push notification settings are associated with various locations and store said association for use by the user computing device. For example, a user may enable badge icons on associated applications to indicate that there is new information within the application, or may allow notifications to appear either as alerts or containing information on the home screen or lock screen of a user device. Based on the manipulation of these various settings at various locations, patterns of associations between sets of settings and locations may be determined. The historical use data may also be constantly stored and utilized such that variations from a standard use pattern may be recognized.

Settings, as used herein, may be any number of configurable settings associated with a user device. For example, settings may be the brightness of a screen associated with a user device, the decibel level of the sound played when a call or notification is received, the number, type, and form of notifications such as push notifications, and the like. Additional settings may be the enabling or disabling of a silent or do not disturb mode of the user device. Additionally or alternatively, the settings may be associated with automatic replies such as for email, text, or call notifications. For example, a user may wish to enable automatic replies for email, text, or call communications under certain circumstances such as when traveling or on vacation.

At a second step 320, it is determined that the user device has moved from the first location to the second location. This may be determined based on a user device connecting to a new base station, or based on GPS data associated with the user device. For example, a user may travel from a home location to a work location or from a work location to a home location. In additional or alternative embodiments, a first location may be associated with a regular travel location for the user device and a second location may be associated with an irregular travel location for the user device. For example, a user may regularly travel within Kansas City, Missouri. This standard geographic area of a city, state, or municipality may be associated with the first location. If a user device were to travel outside of this first location, for example to travel to a different city, state, or country, it may be determined that the user device has moved from the first location to the second location.

In said example, the user device may determine that settings associated with the first location need to be updated. For example, an alarm clock set for 6 AM may need to be updated to disable the alarm clock or to update it to a new time zone for the user as the user has moved from the first location to the second location. In additional or alternative embodiments, a user may have a preset away notification that is automatically transmitted when a third party attempts to communicate with the user over text, email or call via a third party user device. When it is determined that the user device is located at the second location, it may be determined that the away notifications need to be turned on to inform third parties that the user is away from work or on a vacation. As such, the set of settings of the user device may be updated to enable the away notifications.

At a third step 330, the user device is automatically updated from the first set of settings to the second set of settings. As discussed above, the associated sets of settings and locations may be dynamically used to automatically update the settings of the user device when the user device travels from location to location. This may take effect when traveling from a home location to a work location, or from a regular location to an irregular location. And any number and type of settings may be updated based on associated locations and changes in location. For example, it may be determined that the user device has moved from a first location to a second location, and based on this determination, automatically enable automatic replies for emails, text, and/or calls indicating that the user is away from the office or on vacation.

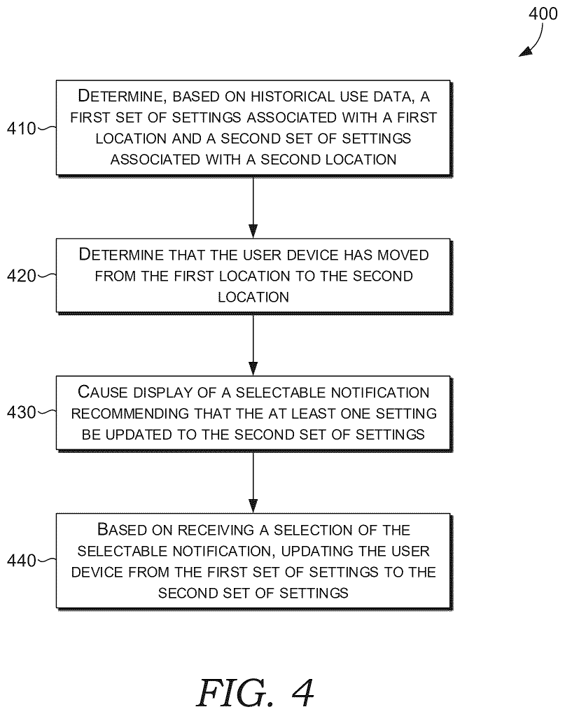

Turning now to FIG. 4, a flow chart is provided for an additional or alternative method 400. At a first step 410, a first set of settings associated with a first location and a second set of settings associated with a second location are determined based on historical use data. The historical use data may be comprised of any data associated with a user's use of a user device and the locations at which that use takes place. For example, the enabling or disabling of certain settings may constitute historical use data. At a second step 420, it is determined that the user device has moved from the first location to the second location. At a third step 430, the method comprises causing display of a selectable notification recommending that the at least one setting be updated to the second set of settings.

At a fourth step 440, based on receiving a selection of the selectable notification, the user device is updated from the first set of settings to the second set of settings. In additional or alternative embodiments, the selectable notification may be caused to display after the user computing device has already automatically updated the set of settings. In said embodiment, the user may select the selectable notification in order to deny the updates and revert the set of settings to the previous set of settings. In additional or alternative embodiments, it may be determined that a user device has returned from the second location to the first location, and based on this determination, the user device may automatically update the user device from the second set of settings to the first set of settings.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A method for updating at least one setting of a user device, the method comprising:
determining, based on historical use data, a first set of settings associated with a first location and a second set of settings associated with a second location;
determining that the user device has moved from the first location to the second location; and
automatically updating the user device from the first set of settings to the second set of settings.

2. The method of claim 1, further comprising:
causing display of a notification indicating that the first set of settings has been updated to the second set of settings, wherein the notification comprises a selectable option.

3. The method of claim 2, further comprising:
causing the user device to revert from the second set of settings to the first set of settings based on receiving a selection of the selectable option.

4. The method of claim 1, wherein the historical use data is comprised of GPS data and device usage data.

5. The method of claim 1, wherein a machine learning model is utilized in determining the first set of settings associated with the first location and the second set of settings associated with the second location.

6. The method of claim 1, wherein updating from the first set of settings to the second set of settings comprises enabling a do not disturb mode.

7. The method of claim 1, wherein updating from the first set of settings to the second set of settings comprises disabling push notifications.

8. A system for updating at least one setting of a user device, the system comprising:
one or more computer processing components configured to perform operations comprising:
determining, based on historical use data, a first set of settings associated with a first location and a second set of settings associated with a second location;
determining that the user device has moved from the first location to the second location; and
automatically updating the user device from the first set of settings to the second set of settings.

9. The system of claim 8, further comprising:
causing display of a notification indicating that the first set of settings has been updated to the second set of settings, wherein the notification comprises a selectable option.

10. The system of claim 9, further comprising:
causing the user device to revert from the second set of settings to the first set of settings based on receiving a selection of the selectable option.

11. The system of claim 8, wherein the historical use data is comprised of GPS data and device usage data.

12. The system of claim 8, wherein a machine learning model is utilized in determining the first set of settings associated with the first location and the second set of settings associated with the second location.

13. The system of claim 8, wherein updating from the first set of settings to the second set of settings comprises enabling a do not disturb mode.

14. The system of claim 8, wherein updating from the first set of settings to the second set of settings comprises disabling push notifications.

15. A method for updating at least one setting of a user device, the method comprising:
determining, based on historical use data, a first set of settings associated with a first location and a second set of settings associated with a second location;
determining that the user device has moved from the first location to the second location;
causing display of a selectable notification recommending that the at least one setting be updated to the second set of settings; and
based on receiving a selection of the selectable notification, updating the user device from the first set of settings to the second set of settings.

16. The method of claim 15, wherein updating the user device from the first set of settings to the second set of settings comprises enabling a do not disturb mode.

17. The method of claim 15, wherein updating the user device from the first set of settings to the second set of settings comprises disabling push notifications.

18. The method of claim 15, wherein the historical use data is comprised of GPS data and device usage data.

19. The method of claim 15, wherein a machine learning model is utilized in determining the first set of settings associated with the first location and the second set of settings associated with the second location.

20. The method of claim 15 further comprising:
determining that the user device has moved from the second location to the first location; and
automatically updating the user device from the second set of settings to the first set of settings.
